(19) United States
(12) Patent Application Publication
(10) Pub. No.: US 2024/0237608 A1
(43) Pub. Date: Jul. 18, 2024

(54) Pet Cage Pad for Wall Device

(71) Applicant: Brandy Price, Donaldsonville, LA (US)

(72) Inventor: Brandy Price, Donaldsonville, LA (US)

(21) Appl. No.: 18/412,684

(22) Filed: Jan. 15, 2024

Related U.S. Application Data
(60) Provisional application No. 63/439,376, filed on Jan. 17, 2023.

(51) Int. Cl. A01K 1/03

(52) U.S. Cl. CPC A01K 1/033

(57) ABSTRACT

A pet crate pad device is disclosed, that is a specialized padding material for the walls of a pet cage/crate to prevent injury to the pet. The pet crate pad device comprises a body component that is configured in a rectangular shape. The body component would be a manufactured of a tear-resistant, waterproof padding material and typically comprises a three pack of cushions that secure to the inner side of the back and side walls of the crate. The body component also comprises a plurality of metal fasteners, latches, hooks, tie-downs, etc., that removably secure the body component to the crate's walls, as needed. Further, the body component can be detached and is washable/reusable, as needed.

### CROSS-REFERENCE TO RELATED APPLICATION

The present application claims priority to, and the benefit of, U.S. Provisional Application No. 63/439,376, which was filed on Jan. 17, 2023, and is incorporated herein by reference in its entirety.

### FIELD OF THE INVENTION

The present invention relates generally to the field of pet crate pad devices. More specifically, the present invention relates to a pet cage pad that protects pets from harming themselves while inside of the crate. Accordingly, the present disclosure makes specific reference thereto. Nonetheless, it is to be appreciated that aspects of the present invention are also equally applicable to other like applications, devices and methods of manufacture.

### BACKGROUND

By way of background, this invention relates to improvements in pet crate pad devices. Generally, many pets suffer from separation anxiety or get overly excited resulting in the pet swinging their tail or jumping around. When caged in their crate, the pets' tail and other parts of the pets can make contact with the walls of the crate, causing injury.

Furthermore, pets when they are sick, sleeping, or being transported are often placed in a crate. When a pet has to lie in a crate for an extended period of time they can become uncomfortable, since the floor and/or walls are either rigid plastic or metal or a metal grid. As a result, owners often place pillows or pads in the crate to make their pets more comfortable. Unfortunately, pet crates come in many different styles and sizes. As a result, the pillow or pad either crowds the pet or slides around in the crate and doesn't cover the walls, as needed.

Accordingly, there is a demand for an improved pet crate pad device that covers and secures to a pet crate, protecting the pet within the crate. More particularly, there is a demand for a pet crate pad device that provides tear-resistant, waterproof padding which can be detached from the crate and washed, as needed.

Therefore, there exists a long felt need in the art for a pet crate pad device that provides a pet cage pad to protect pets from harming themselves while inside of a crate/cage. There is also a long felt need in the art for a pet crate pad device that features a three-pad system for the back and sides of a crate, that can be easily detached when not in use. Further, there is a long felt need in the art for a pet crate pad device that prevents serious injury to the paws, skin or tail area of a pet due to separation anxiety. Moreover, there is a long felt need in the art for a device that allows pet owners, pet boarding businesses, or pet sitters an effective way to keep a pet safe. Further, there is a long felt need in the art for a pet crate pad device that eliminates serious injury, infection or having to take the pet to a veterinarian. Finally, there is a long felt need in the art for a pet crate pad device that can be detached and washed, as needed.

The subject matter disclosed and claimed herein, in one embodiment thereof, comprises a pet crate pad device. The device is a specialized padding material for the walls of a pet cage/crate to prevent injury to the pet. The pet crate pad device comprises a body component that is a three-pad system, with each pad configured in a rectangular shape that measures approximately the length of the crate walls and is approximately 1-2 inches in thickness. The body component would be a manufactured of a tear-resistant, waterproof padding material and typically comprises a three pack of cushions that secure to the inner side of the back and side walls of the crate. The body component also comprises a plurality of metal fasteners, latches, hooks, tie-downs, etc., that removably secure the body component to the crate's walls, as needed. The plurality of metal fasteners and such, should keep the body component in place and should withstand tugging, a pet laying up against the body component, or clawing. Further, the body component can be detached and is washable/reusable, as needed.

In this manner, the pet crate pad device of the present invention accomplishes all of the forgoing objectives and provides users with a device that protects pets when inside their crates. The device is a pad that is secured to the interior walls of the crate. The device can be manufactured of a tear-resistant, waterproof material.

### SUMMARY OF THE INVENTION

The following presents a simplified summary in order to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a pet crate pad device. The device is a specialized padding material for the walls of a pet cage/crate to prevent injury to the pet. The pet crate pad device comprises a body component that is a three-pad system secured to the interior walls of a pet crate. The body component also comprises a plurality of fasteners that removably secure the body component to the crate's walls. Further, the body component can be detached and is washable/reusable, as needed.

In one embodiment, the pet crate pad device is positioned within any suitable pet crate as is known in the art, as long as the pet crate has side walls and a back wall to support the pet crate pad device. Further, the pet crate pad device comprises a body component. The body component is typically a three-pad system which acts to cover the interior walls of a pet crate. The three-pad body component would comprise a three pack of cushions or pads that secure to the inner side walls and the back wall of the pet crate. Specifically, the three-pad body component is comprised of three separate cushions or pads packaged together, then secured to the interior walls of the pet crate. However, any suitable number of pads or cushions can be utilized as is known in the art.

In one embodiment, each of the pads or cushions of the body component is configured in a rectangular shape that measures approximately the length of the pet crate walls and is approximately 1-2 inches in thickness. However, the body component pads can be any suitable shape and size as is known in the art, as long as they act to cover the majority of the pet crate's interior walls to protect a pet housed within the crate. Further, the body component pads each comprise a front surface, a back surface, opposing right and left side walls, and opposing top and bottom side walls. In position, the back surface is secured to the pet crate walls and the front surface contacts the pet within the crate.

In one embodiment, the back surface of the body component comprises a plurality of fasteners. Any suitable number of fasteners can be utilized depending on the needs and/or wants of a user. The fasteners can be any suitable fastener that is able to secure the body component pads to the pet crate walls, while still allowing the body component pads to be removed and washed, then reused, as needed. Specifically, the plurality of fasteners should keep the body component pads in place and should withstand tugging, a pet laying up against the body component pads, and/or clawing. In one embodiment, the body component pads can be detached and are washable/reusable, as needed. The fasteners include, metal fasteners, latches, hooks, zip-ties, etc., as is known in the art.

In one embodiment, the body component pads are manufactured of a cover having a top fabric and a lower fabric, which holds a filler material. The filler material may be an open or closed cell foam pad or foam pieces or batting or any other suitable material. The top fabric has a fuzzy or furry surface that faces the pet in one embodiment. The fuzzy surface is soft, comfortable, and warm. In one embodiment, the top fabric can be waterproof and tear-resistant. The body component can comprise any suitable material or combinations thereof and is typically of a construction with a cover encasing a filler material.

In one embodiment, the three-pad system of the body component is connected to a central pad that is positioned on the bottom or floor of the pet crate. The central pad is sized and shaped to cover the entire floor of the pet crate and the three-pad system extends out from the sides of the central pad, in an integral, one-piece construction. In another embodiment, the three-pad body component and central pad are separate pieces that are secured together via sewing, adhesives, snaps, etc. Once positioned within the pet crate, the central pad and three-pad body component cover the floor and walls of the pet crate interior. The three-pad body component can then be secured to the walls of the pet crate via a plurality of fasteners.

In one embodiment, the pet crate pad device can be manufactured in a plurality of shapes and sizes, as is known in the art to fit various sized pet crates (i.e., extra-small, small, medium, large, and extra-large).

In yet another embodiment, the pet crate pad device comprises a plurality of indicia.

In yet another embodiment, a method of protecting a pet from injury while in their crate is disclosed. The method includes the steps of providing a pet crate pad device comprising a body component that is a three-pad system with a plurality of fasteners. The method also comprises inserting the body component into the pet crate. Further, the method comprises securing the three-pad system of the body component to the interior walls of the pet crate via the plurality of fasteners. Finally, the method comprises removing the body component for washing/reuse, as needed.

Numerous benefits and advantages of this invention will become apparent to those skilled in the art to which it pertains, upon reading and understanding the following detailed specification.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a front perspective view of one embodiment of the pet crate pad device of the present invention showing the device applied to the interior walls of the pet crate in accordance with the disclosed architecture;

FIG. 2 illustrates a perspective view of one embodiment of the pet crate pad device of the present invention showing the body component secured to the walls in accordance with the disclosed architecture;

FIG. 3 illustrates a perspective view of one embodiment of the pet crate pad device of the present invention showing the body component secured to the walls in accordance with the disclosed architecture;

FIG. 4 illustrates a top perspective view of one embodiment of the pet crate pad device of the present invention showing the body component in position for use in accordance with the disclosed architecture;

FIG. 5 illustrates a perspective view of one embodiment of the pet crate pad device of the present invention in use in accordance with the disclosed architecture; and

FIG. 6 illustrates a flowchart showing the method of protecting a pet from injury while in their crate in accordance with the disclosed architecture.

### DETAILED DESCRIPTION OF THE PRESENT INVENTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there is a long felt need in the art for a pet crate pad device that provides a pet cage pad to protect pets from harming themselves while inside of a crate/cage. There is also a long felt need in the art for a pet crate pad device that features a three-pad system for the back and sides of a crate, that can be easily detached when not in use. Further, there is a long felt need in the art for a pet crate pad device that prevents serious injury to the paws, skin or tail area of a pet due to separation anxiety. Moreover, there is a long felt need in the art for a device that allows pet owners, pet boarding businesses, or pet sitters an effective way to keep a pet safe. Further, there is a long felt need in the art for a pet crate pad device that eliminates serious injury, infection or having to take the pet to a veterinarian. Finally, there is a long felt need in the art for a pet crate pad device that can be detached and washed, as needed.

The present invention, in one exemplary embodiment, is a novel pet crate pad device. The device is a specialized padding material for the walls of a pet cage/crate to prevent injury to the pet. The pet crate pad device comprises a body component that is a three-pad system, wherein each pad is configured in a rectangular shape. The body component would be a manufactured of a tear-resistant, waterproof padding material and typically comprises a three pack of cushions that secure to the inner side of the back and side walls of the crate. The body component also comprises a plurality of metal fasteners, latches, hooks, tie-downs, etc., that removably secure the body component to the crate's walls, as needed. The plurality of metal fasteners and such, should keep the body component in place and should withstand tugging, a pet laying up against the body component, or clawing. The present invention also includes a novel method of protecting a pet from injury while in their crate. The method includes the steps of providing a pet crate pad device comprising a body component that is a three-pad system with a plurality of fasteners. The method also comprises inserting the body component into the pet crate. Further, the method comprises securing the three-pad system of the body component to the interior walls of the pet crate via the plurality of fasteners. Finally, the method comprises removing the body component for washing/reuse, as needed.

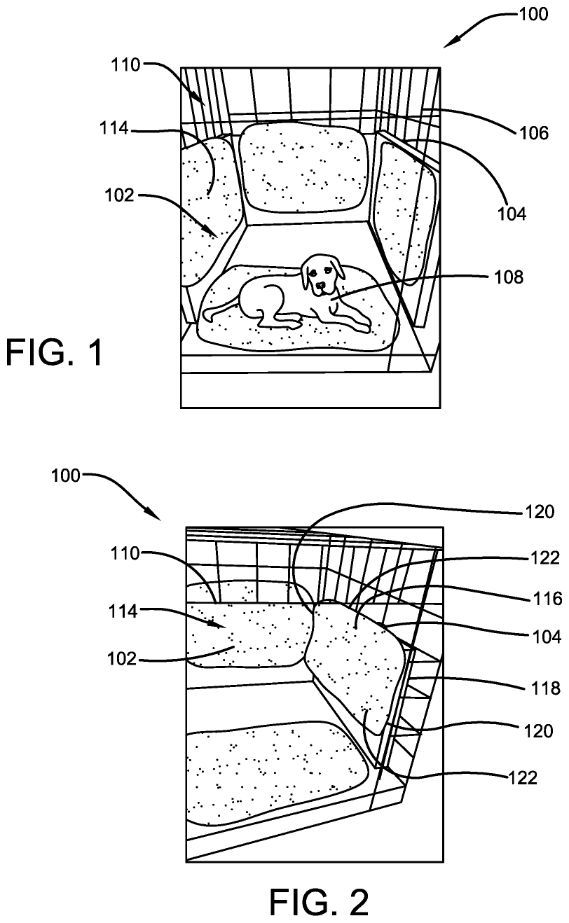

Referring initially to the drawings, FIG. 1 illustrates a perspective view of one embodiment of the pet crate pad device 100 of the present invention. In the present embodiment, the pet crate pad device 100 is an improved pet crate pad device 100 that protects a pet 108 from harming themselves while inside a pet crate/cage 110. Specifically, the pet crate pad device 100 comprises a body component 102 that is a three-pad system, wherein each pad is configured in a rectangular shape. Further, the body component 102 comprises a plurality of fasteners 104 for securing the device 100 to the interior of the crate walls 106 and 112. Additionally, the body component 102 can be detached and is washable/reusable, as needed.

Generally, the pet crate pad device 100 is positioned within any suitable pet crate 110 as is known in the art, as long as the pet crate 110 has side walls 106 and a back wall 112 to support the pet crate pad device 100. Further, the pet crate pad device 100 comprises a body component 102. The body component 102 is typically a three-pad system which acts to cover the interior walls 106 and 112 of a pet crate 110. The three-pad body component 102 would comprise a three pack of cushions or pads 114 that secure to the inner side walls 106 and the back wall 112 of the pet crate 110. Specifically, the three-pad body component 102 is comprised of three separate cushions or pads 114 packaged together, then secured to the interior walls 106 and 112 of the pet crate 110. However, any suitable number of pads or cushions 114 can be utilized as is known in the art.

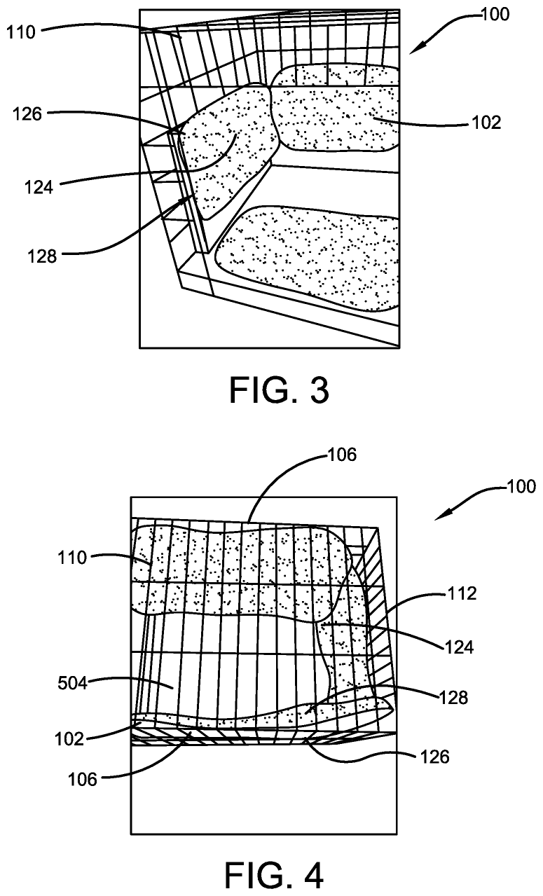

As shown in FIGS. 2-3, each of the pads or cushions 114 of the body component 102 is configured in a rectangular shape that measures approximately the length of the pet crate walls 106 and 112 and is approximately 1-2 inches in thickness. However, the body component pads 102 can be any suitable shape and size as is known in the art, as long as they act to cover the majority of the pet crate's interior walls 106 and 112 to protect a pet 108 housed within the crate 110. Further, the body component pads 102 each comprise a front surface 116, a back surface 118, opposing right and left side walls 120, and opposing top and bottom side walls 122. In position, the back surface 118 is secured to the pet crate walls 106 and 112 and the front surface 116 contacts the pet 108 within the crate 110.

As shown in FIG. 4, the back surface 118 of the body component 102 comprises a plurality of fasteners 104. Any suitable number of fasteners 104 can be utilized depending on the needs and/or wants of a user. The fasteners 104 can be any suitable fastener that is able to secure the body component pads 102 to the pet crate walls 106 and 112, while still allowing the body component pads 102 to be removed and washed, then reused, as needed. Specifically, the plurality of fasteners 104 should keep the body component pads 102 in place and should withstand tugging, a pet 108 laying up against the body component pads 102, and/or clawing. In one embodiment, the body component pads 102 can be detached and are washable/reusable, as needed. The fasteners 104 include, metal fasteners, latches, hooks, zip-ties, etc., as is known in the art.

Further, the body component pads 102 are manufactured of a cover having a top fabric 124 and a lower fabric 126, which holds a filler material 128. The filler material 128 may be an open or closed cell foam pad or foam pieces or batting or any other suitable material, as is known in the art. The top fabric 124 has a fuzzy or furry surface that faces the pet 108 in one embodiment. The fuzzy surface is soft, comfortable, and warm. In one embodiment, the top fabric 124 can be waterproof and tear-resistant. The body component 102 can comprise any suitable material or combinations thereof and is typically of a construction with a cover 124 encasing a filler material 128.

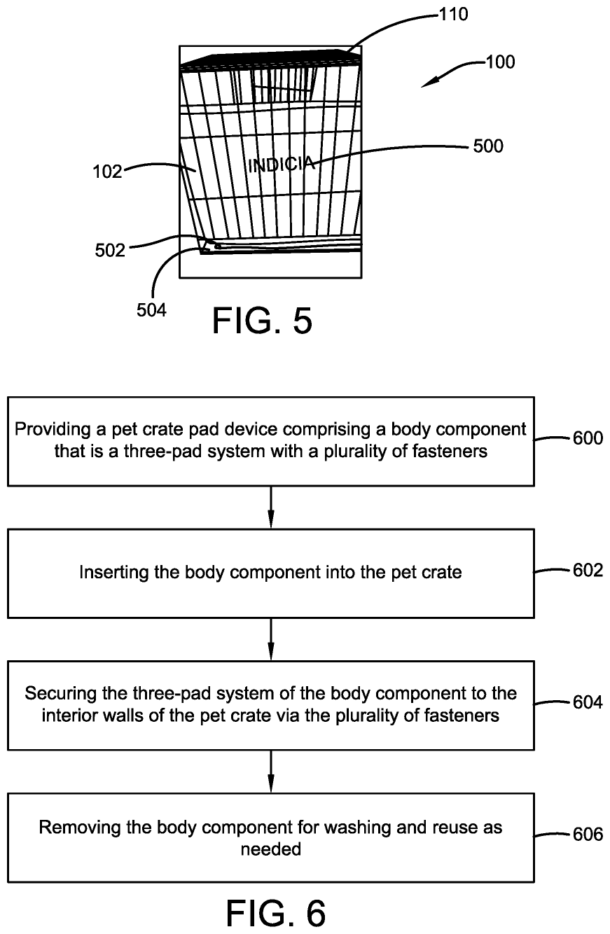

As shown in FIG. 5, in one embodiment, the three-pad system of the body component 102 is connected to a central pad 502 that is positioned on the bottom or floor 504 of the pet crate 110. The central pad 502 is sized and shaped to cover the entire floor 504 of the pet crate 110 and the three-pad system extends out from the sides of the central pad 502, in an integral, one-piece construction. In another embodiment, the three-pad body component 102 and central pad 502 are separate pieces that are secured together via sewing, adhesives, snaps, etc. Once positioned within the pet crate 110, the central pad 502 and three-pad body component 102 cover the floor 504 and walls 106 and 112 of the pet crate 110 interior. The three-pad body component 102 can then be secured to the walls 106 and 112 of the pet crate 110 via a plurality of fasteners 104.

Generally, the pet crate pad device 100 can be manufactured in a plurality of shapes and sizes, as is known in the art to fit various sized pet crates 110 (i.e., extra-small, small, medium, large, and extra-large), depending on the wants and/or needs of a user.

In yet another embodiment, the pet crate pad device 100 comprises a plurality of indicia 500. The body component 102 of the device 100 may include advertising, a trademark, or other letters, designs, or characters, printed, painted, stamped, or integrated into the body component 102, or any other indicia 500 as is known in the art. Specifically, any suitable indicia 500 as is known in the art can be included, such as but not limited to, patterns, logos, emblems, images, symbols, designs, letters, words, characters, animals, advertisements, brands, etc., that may or may not be pet crate, cushion, or brand related.

FIG. 6 illustrates a flowchart of the method of protecting a pet from injury while in their crate. The method includes the steps of at 600, providing a pet crate pad device comprising a body component that is a three-pad system with a plurality of fasteners. The method also comprises at 602, inserting the body component into the pet crate. Further, the method comprises at 604, securing the three-pad system of the body component to the interior walls of the pet crate via the plurality of fasteners. Finally, the method comprises at 606, removing the body component for washing/reuse, as needed.

Certain terms are used throughout the following description and claims to refer to particular features or components. As one skilled in the art will appreciate, different users may refer to the same feature or component by different names. This document does not intend to distinguish between components or features that differ in name but not structure or function. As used herein “pet crate pad device”, “pet crate device”, “pad device”, and “device” are interchangeable and refer to the pet crate pad device 100 of the present invention.

Notwithstanding the forgoing, the pet crate pad device 100 of the present invention can be of any suitable size and configuration as is known in the art without affecting the overall concept of the invention, provided that it accomplishes the above stated objectives. One of ordinary skill in the art will appreciate that the pet crate pad device 100 as shown in FIGS. 1-6 is for illustrative purposes only, and that many other sizes and shapes of the pet crate pad device 100 are well within the scope of the present disclosure. Although the dimensions of the pet crate pad device 100 are important design parameters for user convenience, the pet crate pad device 100 may be of any size that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A pet crate pad device that protects a pet from harming themselves while inside a pet crate, the pet crate pad device comprising:
a body component; and
a plurality of fasteners;
wherein the body component comprises multiple pads;
wherein the body component is secured to an interior of a pet crate via the plurality of fasteners; and
further wherein the body component protects a pet and prevents injury.

2. The pet crate pad device of claim 1, wherein the body component is positioned within any size pet crate.

3. The pet crate pad device of claim 2, wherein the body component comprises three pads.

4. The pet crate pad device of claim 3, wherein the three-pad body component secures a pad to each inner side wall and a back wall of the pet crate.

5. The pet crate pad device of claim 4, wherein the three pads are three separate pads packaged together.

6. The pet crate pad device of claim 5, wherein each of the pads of the body component is configured in a rectangular shape that measures approximately a length of the pet crate walls and is approximately 1-2 inches in thickness.

7. The pet crate pad device of claim 6, wherein the pads of the body component pads each comprise a front surface, a back surface, opposing right and left side walls, and opposing top and bottom side walls.

8. The pet crate pad device of claim 7, wherein in position, the back surface is secured to the pet crate walls and the front surface contacts the pet within the pet crate.

9. The pet crate pad device of claim 8, wherein the plurality of fasteners include metal fasteners, latches, hooks, or zip-ties.

10. The pet crate pad device of claim 9, wherein the plurality of fasteners releasably secure the body component to the pet crate walls, thereby allowing the body component to be removed and washed, then reused, as needed.

11. The pet crate pad device of claim 10, wherein the pet crate pad device is manufactured in a plurality of shapes and sizes to fit various sized pet crates.

12. The pet crate pad device of claim 11, wherein the pads of the body component are manufactured of a cover having a top fabric and a lower fabric, which holds a filler material therebetween.

13. A pet crate pad device that protects a pet from harming themselves while inside a pet crate, the pet crate pad device comprising:
a body component comprised of three pads; and
a plurality of fasteners which include metal fasteners, latches, hooks or zip-ties;
wherein the three-pad body component secures a pad to each inner side wall and a back wall of a pet crate via the plurality of fasteners;
wherein each of the pads of the body component is configured in a rectangular shape that measures approximately a length of the pet crate inner side walls or back wall and is approximately 1-2 inches in thickness;
wherein the plurality of fasteners releasably secure the body component to the pet crate inner side walls and back wall, allowing the body component to be removed and washed, then reused, as needed; and
further wherein the plurality of fasteners keep the body component pads in place and should withstand tugging, a pet laying up against the pads of the body component, or clawing.

14. The pet crate pad device of claim 13, wherein the pads of the body component are manufactured of a cover having a top fabric and a lower fabric, which holds a filler material therebetween.

15. The pet crate pad device of claim 14, wherein the filler material is an open or closed cell foam pad or foam pieces or batting.

16. The pet crate pad device of claim 15, wherein the top fabric has a fuzzy or furry surface that faces the pet.

17. The pet crate pad device of claim 13, wherein the body component is waterproof and tear-resistant.

18. The pet crate pad device of claim 13, wherein the body component is connected to a central pad that is positioned on a floor of the pet crate and the pads of the body component extend out from sides of the central pad, in an integral, one-piece construction.

19. The pet crate pad device of claim 13 further comprising a plurality of indicia.

20. A method of protecting a pet from injury while in their crate, the method comprising the following steps:
providing a pet crate pad device comprising a body component that is a three-pad system with a plurality of fasteners;
inserting the body component into the pet crate;
securing the three-pad system of the body component to the interior walls of the pet crate via the plurality of fasteners; and
removing the body component for washing and reuse, as needed.
